(19) United States
(12) Patent Application Publication
(10) Pub. No.: US 2009/0183812 A1
(43) Pub. Date: Jul. 23, 2009

(54) UNIVERSAL BODY-SUPPORT FOR PNEUMATIC TREAD

(75) Inventors: Nair Ana P.B. Hoffmann, Nova Prata (BR); Ivan Stefano Bueno, Nova Prata (BR); Andre Hamerski, Nova Prata (BR); Roni Guerra Filho, Bairro Sao Pelegrino (BR)

Correspondence Address: VOLPE AND KOENIG, P.C., UNITED PLAZA, SUITE 1600, 30 SOUTH 17TH STREET, PHILADELPHIA, PA, 19103, US

(73) Assignee: BORRACHAS VIPAL S.A., Nova Prata (RS) (BR)

(21) Appl. No.: 12/302,482

(22) PCT Filed: Jul. 10, 2007
(86) PCT No.: PCT/BR07/00181

§ 371 Date: Feb. 2, 2009

(30) Foreign Application Priority Data
Jul. 10, 2006 (BR) MU 8601440-4

(51) Int. Cl. B60C 5/00

(52) U.S. Cl. 152/450

(57) ABSTRACT

A universal body-support for pneumatic tread is presented as a finished part for tailored application of any type of tread in which usual frame if formed by talons wings and flat area presenting bearing area and not having tread and tread having base layer coated by an elastomeric layer, compatible to the elastomeric layer, having self-adhesive characteristics and is protected against oxidation and contaminants by a film made of removable plastic material or by braided thread layer.

It is object of the model of utility a ring-shaped body prepared as a single part and for universal use, in order to be acquired by cargo vehicles and passenger vehicles users and by tires rethreading professionals to use as body-support for application of desired and suitable type of treads for immediately attending the need of a directional or traction tire.

It is widely known the technology of pneumatic covers manufacturing for vehicles wheels in general, commonly referred as tires, which are industrially mass-produced for supplying vehicle assembly industry and users reposition industry being the tires produced and sold as finished products in its usual ring-shaped embodiment having peripheral bearing surface presenting the tread, i.e. the thick rubber stripe presenting stiffness and a succession of grooves and tread blocks according to drawings designed for each type of land and pavement.

Thus, said tread presents a variety of embodiments in its contact zone in order to ensure the driver necessary stability, adherence, resistance, and functionality, whether a directional or traction vehicle, according to conditions the vehicle is intended to be used.

Said conceptualization makes evident and justifies existence of thousands of types of drawings for treads and a number of different compositions of elastomeric material from which said treads are made of, specially representing for companies having cargo vehicles and passenger vehicles fleets a huge economical and financial, and practical problem.

From economical view the drawback elapses from heavy immobilization of financial resources to maintain stock for immediate use for substituting worn down tires, or structurally, and as to practical aspect, the problem elapses from manipulation and storage of hundreds of new tires, of several types, necessary to provide the daily need for the fleet having vehicles running under different climate conditions, different roads and use.

The state of art exhibits thousands of patents referring to production engineering of several types of tires contemplating tire unitary and integrated manufacturing having a casing (essentially structured with laminated elements or canvas reinforce by textile cord or metallic wires) having a specific tread as, for example, it is taught by patents EP 897.813 on behalf of Bridgestone, EP 943.837 on behalf of Continental, WO 03/053.662 on behalf of Pirelli, and WO 02/05143 on behalf of Pirelli, all of them related to tire manufacturing and vulcanization as finished product individually characterized by specific constructive and functional aspects so that each tire may be exclusively used in vehicles destined to preset uses like for cities, paved roads, trails, earth roads, desert or wet areas and other.

Besides manufacturing new tires, it is also known as state of art, recapping and rethreading for used tires which present a good state structure and worn down tread, i.e., with tread blocks being lower than the levels of security established for each type of tire.

On said recovering, tread's worn down area is totally polished smoothing external surface from ring-shaped body which is fixed with adhesives and vulcanization of elastomeric material of a tread, specially produced and sold in stripes as avulse part to be used by the recapping garages industry.

In order to remove huge economical and financial, and practical problems hereinabove mentioned, and to permit customized and tailored assembly of the desired type and more suitable tire, by the user himself/herself, it is object of the present Model of Utility a ring-shaped body which is available in a unique format and finished product, having a flat surface prepared to receive, at any moment afterwards, a type of tread, enabling, then, with this new constructive disposition, a universal practical solution to dispose a body-support that allows final construction of a tire having the functional characteristics desired by user who will, by currently means known, fix on said flat surface the model of tread which he/she thinks is more suitable, i.e., allowing manufacturing, at the moment and tailored, the user preferred tire.

Therefore, it is obtained a practical solution for the severe problem of storing a variety of finished tires having several different tread drawings, thanks to functional and usage improvement resulting from availability of a lesser stock of universal use body-support, object of this model of utility and a great variety of stripes of treads involving spaces and lower weights handling, generating practical and economical substantial results.

A subsequent and sensitive advantage provided by functional improvement resulting from universal use body-support in object, elapses from technical possibility offered to any garage for tires recapping, usually equipped with means and equipments for substituting in used tires the worn down treads by new ones, performing in loco vulcanization, in autoclaves, heaters or other devices so that it is possible to assemble and produce new tires, attending to typology required by customers at the moment, i.e., opening in the tire market a niche parallel to big serial industrial productions for a customized attendance.

The same titular from the present model of utility has already developed a universal-like body-support characterized by contemplating a bearing smooth surface in which external elastomeric smooth surface is coated by a layer of tressed cords from different natures, aiming at protecting and printing the mesh on said surface making it rough and grooved by removing said layer at the moment of tread application, as described on application MU 055067/SP (temporary number), on May 31^{st}, 2006.

The present model of utility will be better described with attached illustrative drawings, given by means of example with no limitations, in which:

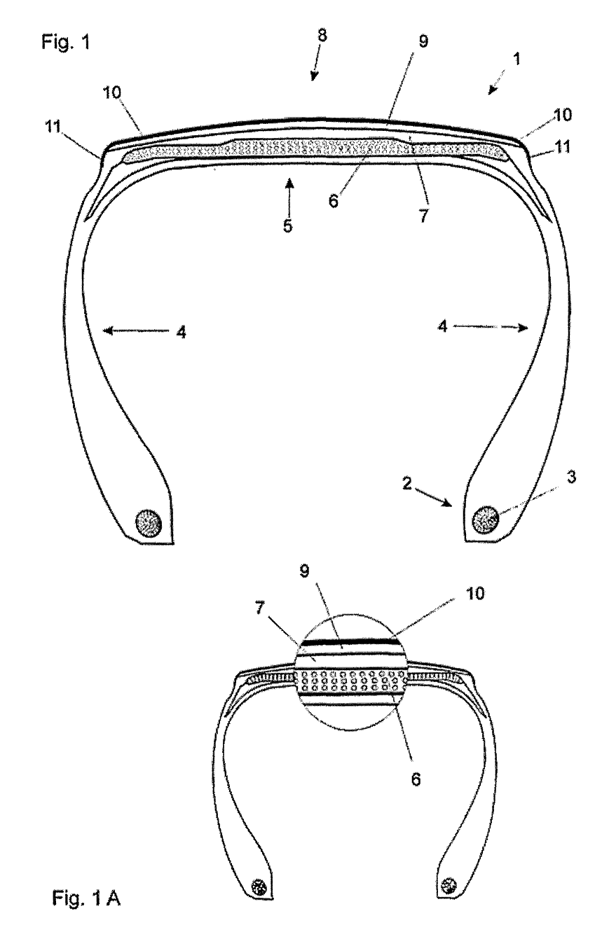

FIG. 1 is a schematic view of straight section of a ring-shaped universal body-support showing the new disposition of materials on tread application area;

FIG. 1A is a wide detailed of the bearing flat area;

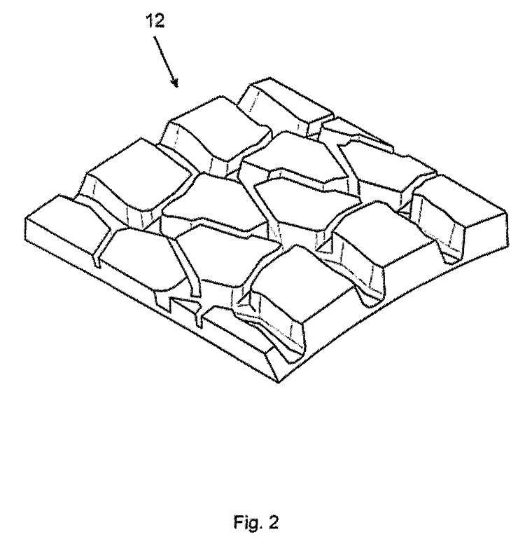

FIG. 2 is a perspective view of a single tread;

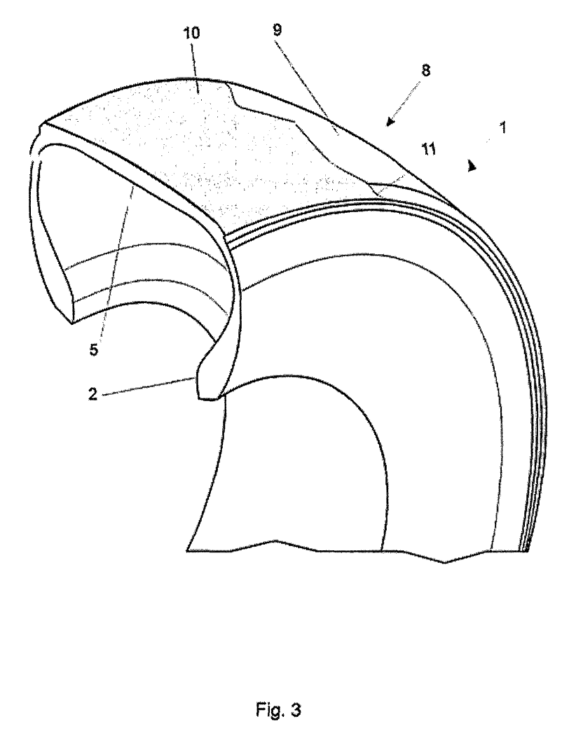

FIG. 3 is a sectioned perspective view from body-support from FIG. 1, as finished product available in the market, and

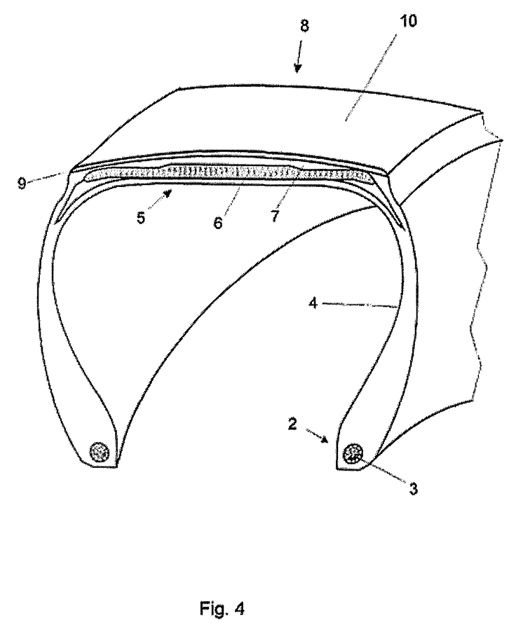

FIG. 4 is a sectioned perspective view from body-support from FIG. 1, ready for being used in the assembly of a tread after being withdrawn the protector antioxidant film.

Universal body-support (1) in object presents the usual schematic structure in straight cut of FIG. 1, presenting talons area (2) reinforced by bunched steel rings (3), wings (4) formed by laminated elastomeric elements and flat area (5) constituted by canvas (6) reinforced by steel wires or natural or artificial textile strings, said canvas (6) being coated by an elastomeric layer (7), all such structure normally composing the frame on which, by the state of art, the tread (constituted by a thick elastomeric stripe shaped by extrusion) is directly shaped by vulcanization on the whole tire in pictures, in which the desired drawing is printed obtaining the new tire as nowadays produced in series and offered to market.

According to new disposition in object it is contemplated said frame finishing (1) as finished product and single, having the flat surface (7) covered by a layer (9) of elastomeric suitable semi-vulcanized material with said layer (7) and having a chemical composition which gives it the self-adhesive characteristics to improve connection to a single stripe of tread (example from FIG. 2) in posterior operation, at the act of use of said body-support on a tire tailored-manufacturing.

According to illustration on FIGS. 1 and 1A said self-adhesive layer (9) is constituted by a elastomeric semi-vulcanized compound based on natural or synthetic rubber having suitable substances and loads to give physical chemical characteristics of compatibility to the subjacent and self-adhesive layer (7), composing with it the base (8) for posterior fixation of stripe (12) of tread (FIG. 2) a an operation separately and tailored performed, on user convenience, of the resulting tire.

On FIGS. 1 and 3 there are illustrations from innovative disposition of a removable film (10) contemplation made of plastic material, like polyethylene, polypropylene, polyester or another, being possible also being made of metallic to increase protection action of said self-adhesive layer (9), against oxidation and other possible contaminations facing non-determined and variable permanence time of body-support (1) in stock until application of tread. Alternatively said film may be constituted by a removable layer of tressed cotton, polyamide, polyester cords or any other material suitable for protection.

Said film (10) presents width in excess to base width (7) and to self-adhesive layer (9), projecting by its borders (11) in a way to promote strength application areas to manually take it out at the moment of fixation of stripe of the tread (12).

According to what is contemplated on previous model of utility of the same titular MU 055067/SP (temporary number), on May 31^{st}, 2006, said superior layer (9) of base (8) may suffer compression with formation of roughness (grooves) whether by film overlap (10) by a natural, synthetic or metallic tressed string layer, or by molding action of a picture in a way the said universal body-support (1) present said surface (9) made of self-adhesive material even more receptive for adhesive material at the moment of fixation of tread.

On FIG. 3 there is an illustration of schematic universal body-support in object in its appearance as finished product, available in the market with bearing surface (8), having self-adhesive layer (9) protected by the film (10, 11), to be removed at the moment of using body-support (1) for immediate use on a tire tailored-manufacturing (FIG. 4), said bearing area (8) being possible to present roughness to make it easier retention of adhesive material.

In another alternative disposition the body-support (1) may have its base area (8) with smooth surface, being roughness obtained by mechanical scrabbling at the moment of fixation of the tread (12).

In a further alternative disposition the self-adhesive layer is fixed down at the stripe of the tread (12), in which base (8) will be formed by elastomeric layer (7).

By new dispositions of the present model of utility, practical and economical abovementioned advantages are reached characterizing the inventive level in a context of absolute novelty, once never commercialize frames in tires as finished single products, superficially prepared, in order to allow storage by consumer-user and the tailored use at the moment for manufacturing in loco of new tires being as user's free decision the choice of preferred tread, starting from units of several types, equally storable and affixable by known techniques of complementary vulcanization in situ.

1. A universal body-support arrangement for pneumatic covers having talons, wings and a flat area constituted by reinforced canvas layers and a base elastomeric layer forming a bearing area, the body being finished without tread having peripheral flat area of bearing coated by a layer of elastomeric semi-vulcanized material compatible to the elastomeric base layer, having self-adhesive characteristics forming in a set, base for application of a tread thereto, said coating layer being protected against oxidation and contaminants by a film made of removable plastic material or by a removable braided thread layer.

2. The universal body-support arrangement for pneumatic covers according to claim 1, wherein the protector film comprises polypropylene, polyethylene, polyester or a metal.

3. The universal body-support arrangement for pneumatic covers according to claim 1, wherein the removable braided thread layer comprises cotton, polyamide, or polyester.

4. The universal body-support arrangement for pneumatic covers according to claim 1, wherein the body is universal, able to receive on the flat base, after removing protector film or braided thread layer, any type of tread.

5. The universal body-support arrangement for pneumatic covers according to claim 1, wherein the bearing flat area comprises a self-adhesive surface of the base having roughness and grooves.

6. The universal body-support arrangement for pneumatic covers according to claim 1, wherein the body-support comprises a base area having a smooth surface.

7. The universal body-support arrangement for pneumatic covers according to claim 1, wherein the self-adhesive layer is internally fixed to a stripe of the tread.
